(19) United States
(12) Patent Application Publication
(10) Pub. No.: US 2026/0254178 A1
(43) Pub. Date: Aug. 27, 2026

(54) ELECTRICAL CONNECTOR DEVICE

(71) Applicant: ABB Schweiz AG, Baden (CH)

(72) Inventors: Ankur Das, Jackson, TN (US); Luke Wowk, Plainville, CT (US); Steven E. Richard, Selmer, TN (US)

(21) Appl. No.: 19/065,295

(22) Filed: Feb. 27, 2025

(51) Int. Cl. H01R 25/14; H01R 43/20

(52) U.S. Cl. CPC H01R 25/142; H01R 43/20

(57) ABSTRACT

An electrical connector device is configured to connect to a busway to provide electrical power to a device and includes a housing body, a first connector base including a first plurality of connectors configured to couple to a first outlet on the busway and draw a first quantity of electrical power from the busway through the first outlet and is disposed on a first portion of the housing body, a second connector base including a second plurality of connectors configured to couple to a second outlet on the busway and draw a second quantity of electrical power from the busway through the second outlet and is disposed on the first portion of the housing body, and at least one conductor disposed within the housing that is configured to electrically connect the first connector base and the second connector base and balance the first and second quantities of electrical power.

### TECHNICAL FIELD

The field of disclosure relates generally to electrical connector devices, and more particularly, to electrical connector devices having a plurality of connector bases for connecting to and drawing electrical power from a busway.

### BACKGROUND

Currently in the industry, busways are used to carry electrical power and connect electrical equipment for power distribution within facilities where the electrical power is needed in different locations, such as data centers and industrial facilities. Bus plugs are connected to these busways to distribute the electrical power from the busways to a load, such as industrial machinery. However, existing bus plugs are limited in their power drawing capabilities and may only be used to draw a specified amount of power from the busway and deliver the specified amount of power to the load. In an effort to maintain effective thermal performance and efficiency, these existing bus plugs may decrease the amount of electrical power drawn by these bus plugs. In some cases, the loads may require more power than the existing bus plugs are capable of delivering.

Based on the foregoing, a need exists for an electrical connector device that is capable of drawing increased amounts of power from the busway without affecting thermal efficiency of the electrical connector device.

This background section is intended to introduce the reader to various aspects of art that may be related to various aspects of the present disclosure, which are described and/or claimed below. This discussion is believed to be helpful in providing the reader with supporting information to facilitate a better understanding of the various aspects of the present disclosure. Accordingly, it should be understood that these statements are to be read in this light, and not as admissions of prior art.

### BRIEF DESCRIPTION

In one aspect, an electrical connector device is described. The electrical connector device is configured to connect to a busway to provide electrical power to a device. The electrical connector device comprises a housing body, a first connector base disposed on a first portion of the housing body. The first connector base comprises a first plurality of connectors configured to couple to a first outlet on the busway and draw a first quantity of electrical power from the busway through the first outlet. The electrical connector device also comprises a second connector base disposed on the first portion of the housing body. The second connector base comprises a second plurality of connectors configured to couple to a second outlet on the busway and draw a second quantity of electrical power from the busway through the second outlet. The electrical connector device comprises at least one conductor disposed within the housing. The at least one conductor is configured to electrically connect the first connector base and the second connector base and balance the first quantity of electrical power and the second quantity of electrical power.

In another aspect, an electrical connector device is described. The electrical connector device is configured to connect to a busway to provide electrical power to a device. The electrical connector device includes a housing body and a first connector base disposed on a first portion of the housing body. The first connector base comprises a first plurality of connectors configured to couple to a first outlet on the busway and draw a first quantity of electrical power from the busway through the first outlet. The electrical connector device further comprises a second connector base disposed on the first portion of the housing body. The second connector base comprises a second plurality of connectors configured to couple to a second outlet on the busway and draw a second quantity electrical power from the busway through the second outlet. The electrical connector device further comprises an electrical switch disposed within the housing. The electrical switch is configured to actuate between a closed position to allow a current flow through the electrical connector device and an open position to interrupt the current flow. The electrical connector device additionally comprises a first plurality of conductors disposed within the housing, wherein the first plurality of conductors are configured to electrically connect the first connector base and the electrical switch and a second plurality of conductors disposed within the housing, wherein the second plurality of conductors are configured to electrically connect the second connector base and the electrical switch.

In yet another aspect, a method for assembling an electrical connector device is described. The method for assembling an electrical connector device comprises providing a housing body for the electrical connector device, providing a first connector base on a first portion of the housing, the first connector base configured to couple to a first outlet on the busway and draw electrical power from the busway, providing a second connector base on the first portion of the housing, the second connector base configured to couple to a second outlet on the busway and draw additional electrical power from the busway, and connecting the first connector base and the second connector base by at least one conductor, wherein the at least one conductor comprises a first phase conductor for a first phase of a plurality of phases, a second phase conductor for a second phase of the plurality of phases, a third phase conductor for a third phase of the plurality of phases, and a neutral conductor.

Various refinements exist of the features noted in relation to the above-mentioned aspects. Further features may also be incorporated in the above-mentioned aspects as well. These refinements and additional features may exist individually or in any combination. For instance, various features discussed below in relation to any of the illustrated examples may be incorporated into any of the above-described aspects, alone or in any combination.

### BRIEF DESCRIPTION OF DRAWINGS

The following drawings form part of the present specification and are included to further demonstrate certain aspects of the present disclosure. The disclosure may be better understood by reference to one or more of these drawings in combination with the detailed description of specific embodiments presented herein.

FIG. 1 depicts an orthogonal view of an electrical connector device coupled to a busway;

FIG. 2 depicts a perspective view illustrating a first portion 24a of a housing 24 for the busway of FIG. 1;

FIG. 3 depicts a first perspective view of the electrical connector device of FIG. 1;

FIG. 4 depicts a perspective view of a connection between a first connector base of the electrical connector device of FIG. 1 and a first busway outlet of the busway of FIG. 1 with a housing for the first busway outlet removed;

FIG. 5 depicts a perspective view of a first connector attachment assembly in an engaged position disposed on an end of the housing proximate the first connector base with a cover for the first connector attachment assembly removed;

FIG. 6 depicts a second perspective view of the electrical connector device of FIG. 1 with a front portion and a top portion of the housing removed;

FIG. 7 depicts a third perspective view of the electrical connector device of FIG. 1 with a top portion and side portions of the housing removed;

FIG. 8 depicts a perspective view of the electrical connector device of FIG. 1 with a top portion, a front portion, and side portions of the housing removed during a first phase of assembly, showing a first riser bar and a second riser bar coupled to a connector of each of a first connector base and a second connector base;

FIG. 9 depicts a perspective view of the first embodiment of the electrical connector device of FIG. 1 with a top portion, a front portion, and side portions of the housing removed during a second phase of assembly, showing a first phase conductor connecting the first connector base and the second connector base;

FIG. 10 depicts a perspective view of the electrical connector device of FIG. 1 with a top portion, a front portion, and side portions of the housing removed during a third phase of assembly, showing a third phase conductor connecting the first connector base and the second connector base;

FIG. 11 depicts a perspective view of the electrical connector device of FIG. 1 with a top portion, a front portion, and side portions of the housing removed during a fourth phase of assembly, showing a neutral conductor connecting the first connector base and the second connector base;

FIG. 12 depicts a perspective view of the electrical connector device of FIG. 1 with a top portion, a front portion, and side portions of the housing removed during a fifth phase of assembly, showing a second phase conductor connecting the first connector base and the second connector base using the first riser bar and the second riser bar;

FIG. 13 depicts an orthogonal view of a second embodiment of an electrical connector device with a front portion of the housing removed;

FIG. 14 depicts a first perspective view of a third embodiment of an electrical connector device with a top portion, a front portion, and side portions of the housing removed; and

FIG. 15 depicts a second perspective view of a third embodiment of an electrical connector device with a top portion and side portions of the housing removed, showing a plurality of lugs.

Corresponding reference characters indicate corresponding parts throughout the several views of the drawings. Although specific features of various examples may be shown in some drawings and not in others, this is for convenience only. Any feature of any drawing may be referenced or claimed in combination with any feature of any other drawing.

### DETAILED DESCRIPTION

The following detailed description and examples set forth preferred materials, components, and procedures used in accordance with the present disclosure. This description and these examples, however, are provided by way of illustration only, and nothing therein shall be deemed to be a limitation upon the overall scope of the present disclosure. The following terms are used in the present disclosure as defined below.

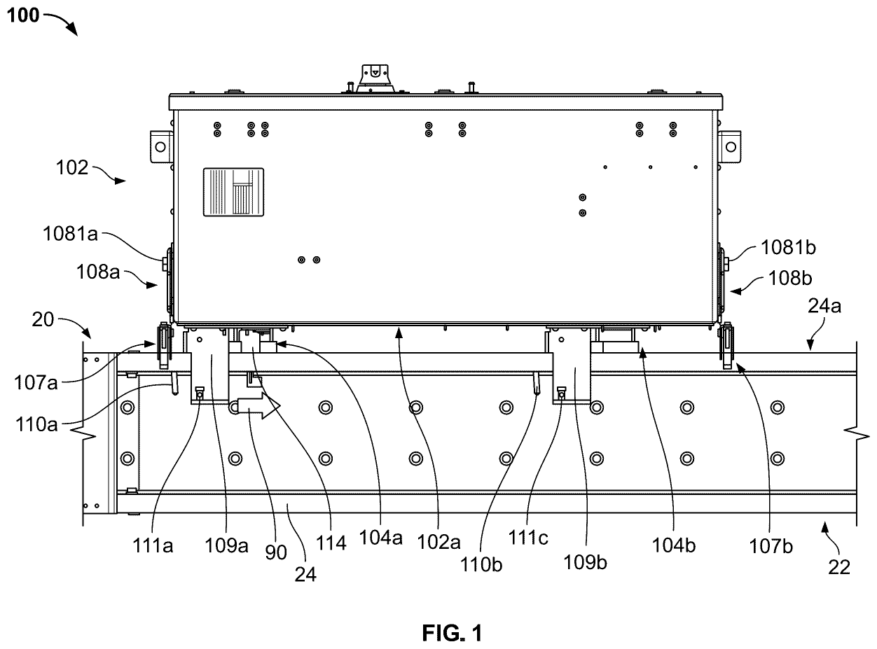

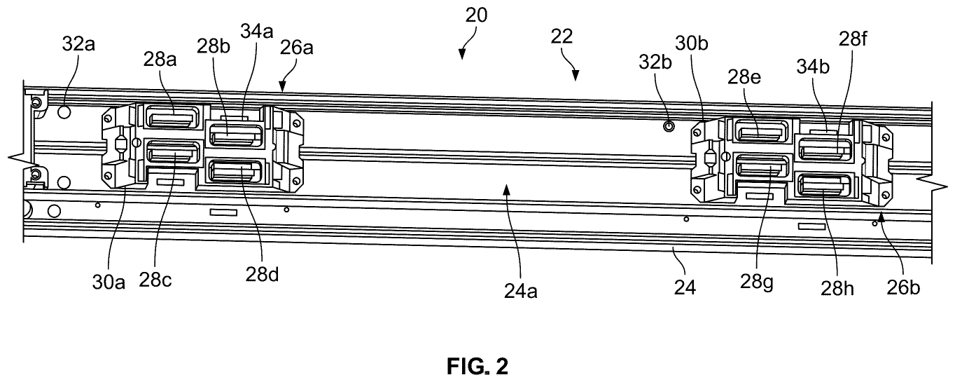

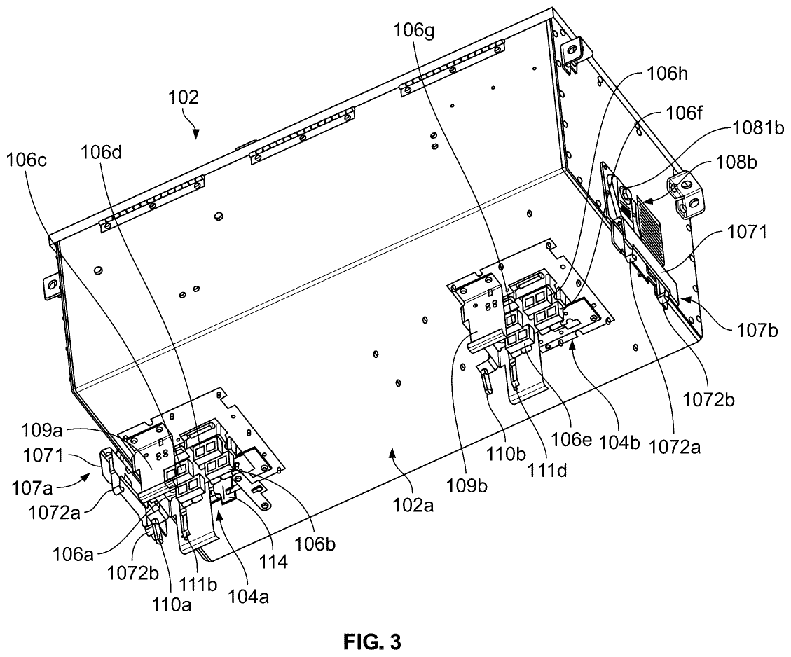

FIG. 1 depicts an orthogonal view of an electrical connector device 100 with a first connector base 104a and a second connector base 104b coupled to a busway 20. FIG. 2 depicts a perspective view illustrating a first portion 24a of a housing 24 for the busway 20 of FIG. 1. FIG. 3 depicts a first perspective view of the electrical connector device of FIG. 1. The busway 20 may include a plurality of busway portions, such as busway portion 22, that define the length and structure of the busway 20. Each busway portion 22 may include a housing 24 and at least one busway conductor (not shown) that extends within the housing 24 and along the length of the busway portion 22. The housing 24 of busway portion 22 may be coupled to the housing 24 of additional busway portions to form a connection, such as a mechanical connection, between each of the busway portions. Additionally, when the busway portions are connected, each of the at least one busway conductor are also connected to a corresponding busway conductor from the additional busway portions to form a connection, such as an electrical connection, between the busway portions 22. The at least one busway conductor may include a busway conductor specific to each of a plurality electrical power phases (e.g., a busway conductor for A-phase, a busway conductor for B-phase, a busway conductor for C-phase, or the like) and a neutral busway conductor. Each busway conductor may be configured to carry electrical power in a specified electrical phase and the neutral busway conductor may be configured to carry a neutral current and balance loads across each of the other busway conductors. The at least one busway conductor may allow the electrical power to be carried within each busway portion 22 and, thereby, allow busway 20 to carry electrical power for distribution.

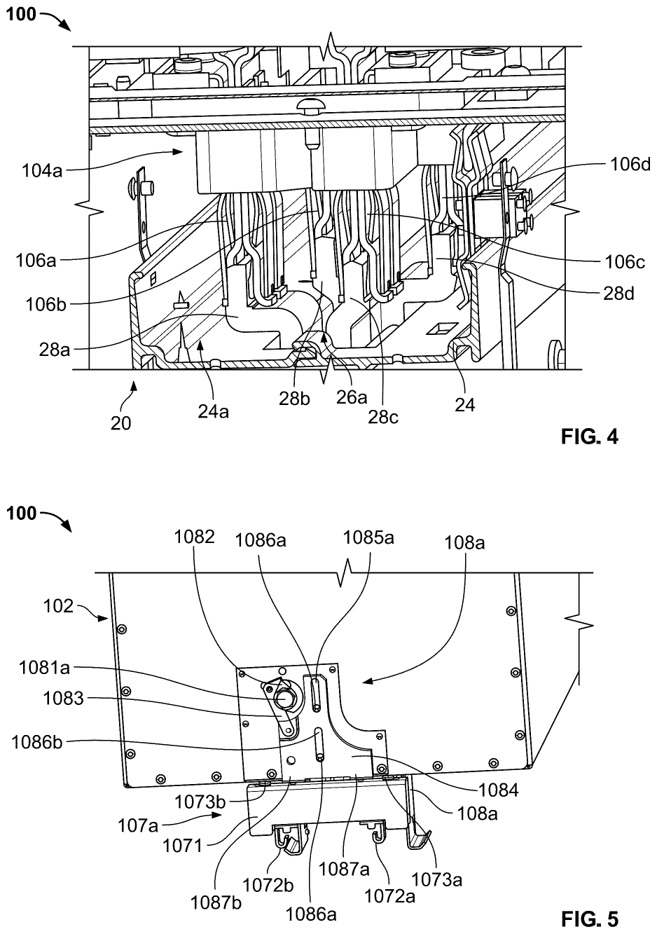

Additionally, the busway 20 may include a plurality of busway outlets, such as busway outlets 26a, 26b (shown in FIG. 2), disposed along a length of the busway 20 at regular intervals on the first portion 24a of the housing 24 of the busway 20. For example, each busway outlet (e.g., busway outlet 26a) may be spaced by an axial length of 24 inches along the length of the busway 20 from an axially adjacent busway outlet (e.g., busway outlet 26b). Each busway outlet may include at least one connector tab, such as connector tabs 28a, 28b, 28c, 28d, 28e, 28f, 28g, 28h (shown in FIG. 2), and each connector tab may correspond to one busway conductor from the at least one busway conductor, described above. For example, as shown in FIG. 2, the busway outlet 26a includes a first connector tab 28a to correspond to a busway conductor for a first phase (e.g., A-phase busway conductor), a second connector tab 28b to correspond to a busway conductor for a second phase (e.g., B-phase busway conductor), a third connector tab 28c to correspond to a busway conductor for a third phase (e.g., C-phase busway conductor), and a fourth connector tab 28d to correspond to a neutral busway conductor. Each connector tab may extend out of the first portion 24a of the housing 24 for the busway 20 and be used to form a connection, such as an electrical connection, between the at least one busway conductor of the busway 20 and an electrical connector device 100, as shown in FIG. 4 and described in more detail below. Each busway outlet 26a, 26b may additionally include a housing 30 configured to receive connector tabs, such as connector tabs 28a, 28b, 28c, 28d, 28e, 28f, 28g, 28h, in corresponding apertures of the housing 30. A cover (not shown) may also attach to the housing 30 to protect the connector tabs 28a, 28b, 28c, 28d, 28e, 28f, 28g, 28h when they are not connected to the electrical connector device 100 or another device. The electrical connector device 100 is configured to provide electrical power from the busway 20 to a load (not shown), such as industrial machinery, through a connection between the electrical connector device 100 and the load. For example, electrical connector device 100 may be configured to provide electrical power from the busway 20 to electronic devices, such as industrial equipment, HVAC systems, or the like, that are connected to the electrical connector device 100.

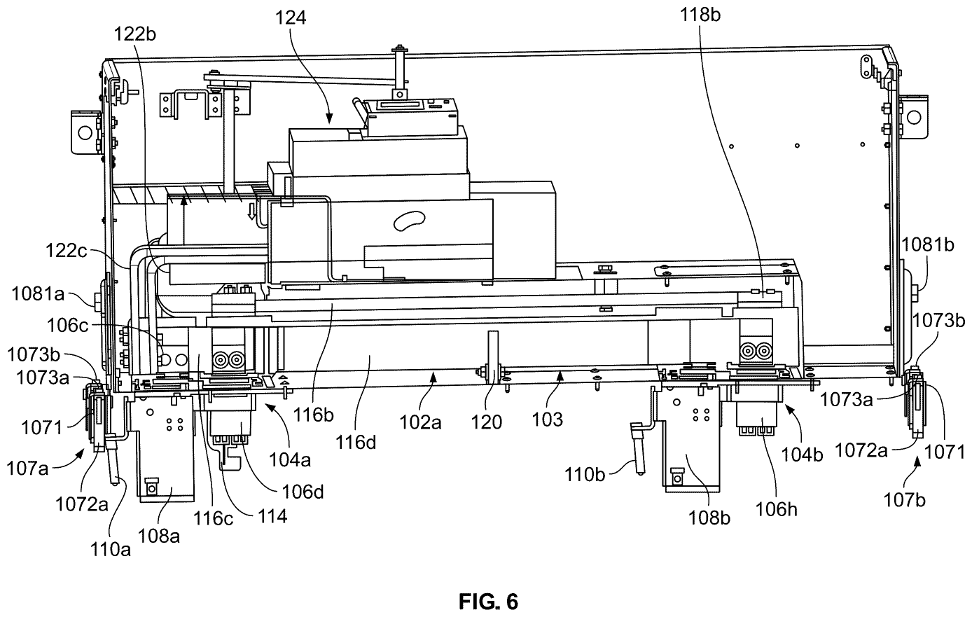

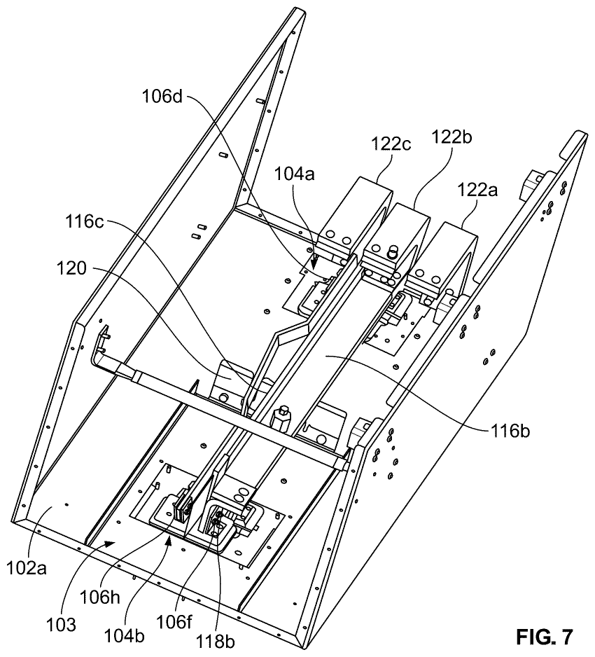

As shown in FIG. 1, the electrical connector device 100 includes a housing 102. The housing 102 is configured to house internal components of electrical connector device 100, such as, but not limited to, conductors 116a, 116b, 116c, 116d, conductor support 120, riser conductors 122a, 122b, 122c, and electrical switch 124, as shown in FIGS. 6 and 7. Additionally, housing 102 may include a reinforced portion 103 (shown in FIG. 7) on a portion of the housing 102, such as portion 102a. The reinforced portion 103 may be configured to additional support and rigidity to portion 102a and/or the housing 102. The reinforced portion 103 may prevent deformation of the portion 102a and/or the housing 102 during installation of the electrical connector device 100 on busway 20 and increase durability of the housing 102.

Additionally, the electrical connector device 100 includes a first connector base 104a and a second connector base 104b. Each of the first connector base 104a and the second connector base 104b may be positioned on a single portion of the housing 102, such as portion 102a. In an embodiment, the first connector base 104a and the second connector base 104b may be spaced by an axial length of 24 inches along the portion 102 a of the housing 102 to match a spacing between busway outlets on the busway 20 and allow the electrical connector device 100 to connect with neighboring busway outlets. The first connector base 104a and the second connector base 104b may be configured to establish the first connection and the second connection with consecutive busway outlets positioned along the busway 20. As shown in FIG. 3, the first connector base 104a and the second connector base 104b are each positioned on portion 102a of the electrical connector device 100, where portion 102a is positioned proximate the busway 20 to allow the first connector base 104a and the second connector base 104b to establish a connection, such as an electrical connection, with respective busway outlets on the busway 20.

More specifically, the first connector base 104a may include a plurality of connectors 106a, 106b, 106c, 106d and the second connector base 104b may include a plurality of connectors 106e, 106f, 106g, 106h, as shown in FIG. 3, to establish an electrical connection with the busway 20 through the two busway outlets. The connectors 106a, 106b, 106c, 106d, 106e, 106f, 106g, 106h may be, for example and without limitation, stabs. However, it will be appreciated by those of ordinary skill in the art that any type of connector capable of establishing an electrical connection with the busway conductors may be used. Each connector of the plurality of connectors 106a, 106b, 106c, 106d, 106e, 106f, 106g, 106h is configured to receive a corresponding connector tab of a busway outlet of the busway 20. FIG. 4 depicts a connection between the first connector base 104a of the electrical connector device 100 and the first busway outlet 26a of the busway 20 with a housing 30a for the first busway outlet 26a removed. For example, in an embodiment, the first connector base 104a may include a first connector 106a configured to receive a first connector tab associated with a first electrical power phase (e.g., connector tab 28a), a second connector 106b configured to receive a second connector tab associated with a second electrical power phase (e.g., connector tab 28b), a third connector 106c configured to receive a third connector tab associated with a third electrical power phase (e.g., connector tab 28c), and a fourth connector 106d configured to receive a neutral connector tab (e.g., connector tab 28d) to establish the connection between the electrical connector device 100 and the busway 20 using a first busway outlet (e.g., busway outlet 26a or the like) located on the first portion 24a of the housing 24 of the busway 20, as shown in FIG. 4. Each of the connector tabs 28a, 28b, 28c, 28d of busway outlet 26a extend outwardly from the first portion 24a of the housing 24 to allow the connectors 106a, 106b, 106c, 106d to receive the corresponding connector tabs 28a, 28b, 28c, 28d, as described above.

The second connector base 104b may include a first connector 106e configured to receive a first connector tab associated with a first electrical power phase (e.g., connector tab 28e), a second connector 106f configured to receive a second connector tab associated with a second electrical power phase (e.g., connector tab 28f), a third connector 106g configured to receive a third connector tab associated with a third electrical power phase (e.g., connector tab 28g), and a fourth connector 106h configured to receive a neutral connector tab (e.g., connector tab 28h) to establish the connection between the electrical connector device 100 and the busway 20 using a second busway outlet (e.g., busway outlet 26b or the like) located on the first portion 24a of the housing 24 of the busway 20. Each of the connector tabs 28e, 28f, 28g, 28h of busway outlet 26b extend outwardly from the first portion 24a of the housing 24, similar to connector tabs 28a, 28b, 28c, 28d, to allow the connectors 106e, 106f, 106g, 106h to receive the corresponding connector tabs. The coupling of the connectors 106e, 106f, 106g, 106h of the second connector base 104b and the connector tabs 28e, 28f, 28g, 28h may be similar to the coupling of the connectors 106a, 106b, 106c, 106d and the connector tabs 28a, 28b, 28c, 28d shown in FIG. 4.

Additionally, the plurality of connectors 106a, 106b, 106c, 106d of the first connector base 104a may be used to establish a plurality of first connections between electrical connector device 100 and the busway 20 to enable the electrical connector device 100 to draw a first quantity of electrical power from the busway 20 through the first busway outlet, such as busway outlet 26a. For example, first connector 106a of the first connector base 104a may be configured to draw electrical power in the first phase from the busway 20, second connector 106 b of the first connector base 104a may be configured to draw electrical power in the second phase from the busway 20, and third connector 106c of the first connector base 104a may be configured to draw electrical power in the third electrical power phase from the busway 20 for the first quantity of electrical power through the first busway outlet. The plurality of connectors 106e, 106f, 106g, 106h of the second connector base 104b may be used to establish a plurality of second connections between the electrical connector device 100 and the busway 20 to enable the electrical connector device 100 to draw a second quantity of electrical power from the busway 20 through the second busway outlet, such as busway outlet 26b. For example, first connector 106e of the second connector base 104b may be configured to draw electrical power in the first phase from the busway 20, second connector 106 f of the second connector base 104 b may be configured to draw electrical power in the second phase from the busway 20, and third connector 106c of the second connector base 104b may be configured to draw electrical power in the third phase from the busway 20 for the second quantity of electrical power through the second busway outlet. The plurality of second connections between the electrical connector device 100 and the busway 20 provides for additional connections between the electrical connector device 100 and the busway 20 that can be used to draw increased amounts of electrical power from the busway 20.

The electrical connector device 100 may additionally include at least one of a first support 107a and a second support 107b. The first support 107a may be disposed on housing 102 on an end proximate the first connector base 104a. The second support 107b may be disposed on housing 102 on an end proximate the second connector base 104b. The first support 107a and the second support 107b may have each a bracket 1071 and a first hook 1072a and a second hook 1072b (shown in FIG. 3) disposed within the bracket 1071. The first hook 1072a and the second hook 1072b are configured to engage a lip on an edge of a first side of the housing 24 of the busway 20 and a lip on an edge of a second side of the housing 24, respectively, to couple the electrical connector device 100 to the busway 20, as shown in FIG. 1. Additionally, the first support 107a and the second support 107b each include a first fastener 1073a that is configured to tighten the first hook 1072a into engagement with (e.g., hook onto) the lip on the first side of the housing 24 and secure the electrical connector device 100 against the busway 20. The first attachment assembly 107a and the second support 107b each include a second fastener 1073b that is configured to tighten the second hook 1072b into engagement with (e.g., hook onto) the lip on the edge of the second side of the housing 24 and secure the electrical connector device 100 against the busway 20.

The electrical connector device 100 may additionally include at least one of a first connector attachment assembly 108a and a second connector attachment assembly 108b. The first connector attachment assembly 108a may be configured to engage with first support 107a to facilitate coupling and ensure proper alignment of the plurality of connectors 106a, 106b, 106c, 106d and the connector tabs 28a, 28b, 28c, 28d for a first busway outlet 26a. The second connector attachment assembly 108b may be configured to engage with second support 107b to facilitate coupling and ensure proper alignment of the plurality of connectors 106e, 106f, 106g, 106h and the connector tabs 28a, 28b, 28c, 28d for a second busway outlet 26b. The first attachment assembly 108a may be disposed on a first end of the housing 102 that is proximal to the first connector base 104a to engage with the bracket 1071 of first support 107a to assist in proper alignment and coupling of the plurality of connectors 106a, 106b, 106c, 106d and the connector tabs 28a, 28b, 28c, 28d for a first busway outlet 26a. The second attachment assembly 108b may be disposed on housing 102 on a second end, that is proximate the second connector base 104b and opposite of the first end, of the housing 102, as shown in FIG. 1. The second attachment assembly 108b may be configured to engage with second support 107b to assist in proper alignment and coupling of the plurality of connectors 106e, 106f, 106g, 106h and the connector tabs 28e, 28f, 28g, 28h for a second busway outlet 26b.

FIG. 5 depicts the first connector attachment assembly 108a in an engaged position disposed on an end of the housing 102 proximate the first connector base 104a with a cover for the first connector attachment assembly 108a. The first connector attachment assembly 108a may include a bolt 1081a to control actuation of the first connector attachment assembly 108a, a visual indicator 1082a configured to provide an indication of a state of connector attachment assembly 108a (e.g., engaged, disengaged, or the like) based on a position of the bolt 1081a, an arm 1083a that is operably coupled to the bolt 1081a at a first end of the arm 1083a, and a plate 1084a that is operably coupled to the arm 1083a at a second end of the arm 1083a. The plate 1084a may include channels 1085a, 1085b to receive bosses 1086a, 1086b protruding from the housing and hooks 1087a, 1087b configured to engage with bracket 1071 of the first attachment assembly 108a. When bolt 1081a, associated with connector attachment assembly 107a, is rotated in a clockwise direction from a disengaged position (e.g., when the visual indicator 1082a points downward), the bolt 1081a causes the arm 1083a to engage the plate 1084a and the hooks 1087a, 1087b to engage the bracket 1071 of the first support 107a. Since the first hook 1072a and the second hook 1072b of the first support 107a are each engaged with the housing 24 of the busway 20, the engagement of the hooks 1086a, 1086b with the bracket 1071 urges the electrical connector device 100 to be drawn linearly toward the busway 20 and the bosses 1085a, 1085b to move linearly in a first direction (e.g., downward) within the channels 1084a, 1084b, respectively, and allow the plurality of connectors 106a, 106b, 106c, 106d and connector tabs 28a, 28b, 28c, 28d to form an enhanced connection. The bolt 1081a is rotated until the bolt 1081a reaches the engaged position (e.g., when the visual indicator 1082a points upward), as shown in FIG. 5, where connector tabs 28a, 28b, 28c, 28d are fully inserted into the plurality of connectors 106a, 106b, 106c, 106d to form the first connection between the busway 20 and the electrical connector device 100. Note that assembly 108b and bolt 1081b function similarly to move electrical connector device 100 and/or the second connector base 104b into engagement with the busway 20 and/or connector tabs 28e, 28f, 28g, 28h to form the second connection between the busway 20 and the electrical connector device 100.

Additionally, while the electrical connector device 100 is drawn linearly towards the busway 20 by first attachment assembly 108a, the first alignment pin 110a may be pushed through a corresponding aperture, such as aperture 32a (shown in FIG. 2), that is positioned adjacent to the first busway outlet 26a on busway 20. When the first alignment pin is able to be inserted through the aperture 32, the first alignment pin 110a provides an indication to a user that the plurality of connectors 106a, 106b, 106c, 106d are properly aligned with corresponding connector tabs 28a, 28b, 28c, 28d of the first busway outlet 26a. Additionally, the first alignment pin 110a may assist in simplified and enhanced connecting of the plurality of connectors 106a, 106b, 106c, 106d and the connector tabs 28a, 28b, 28c, 28d and prevent damage to such components during coupling of the electrical connector device 100 to the busway 20 by only allowing coupling of the electrical connector device 100 to the busway 20 when the first alignment pin 110a is able to be inserted through aperture 32a.

When the bolt 1081a is rotated in the opposite direction (e.g., a counter clockwise direction), the arm 1083 engages the plate 1084 and causes the electrical connector device 100 to be urged linearly away from the busway 20 and the bosses 1086a, 1086b to move linearly in a second direction (e.g., upward) within the channels 1085a, 1085b, respectively, to enable the device 100 to be removed from connection to the busway 20. Note that assembly 108b and bolt 1081b function similarly to move electrical connector device 100 and/or the second connector base 104b out of engagement with the busway 20 and/or connector tabs 28e, 28f, 28g, 28h.

The electrical connector device 100 may include a first bracket 109a and a first alignment pin 110a coupled to the bracket 109a. The bracket 109a and the first alignment pin 110a may be disposed adjacent to the first connector base 104a. The bracket 109a may be configured to engage portions of the busway 20. More specifically, the bracket 109a includes a first contact 111a configured to engage a first side portion of the busway 20 and a second contact 111b (shown in FIG. 3) configured to engage with a second side portion of the busway 20 in close proximity to the first connector base 104a. Each of the first contact 111a and the second contact 111b may include a sharp edge that is able to remove paint from the first side portion and the second side portion of the busway, respectively, and allow the first contract 111a and the second contact 111b to each form a ground connection between the electrical connector device 100 and the busway 20.

The electrical connector device 100 may include a second bracket 109b and a second alignment pin 110b coupled to the bracket 109b. The bracket 109b and the second alignment pin 110b may be disposed adjacent to the second connector base 104b. The bracket 109b may be configured to engage portions of the busway 20. More specifically, the bracket 109b includes a first contact 111c configured to engage a first side portion of the busway 20 and a second contact 111d (shown in FIG. 3) configured to engage with a second side portion of the busway 20 in close proximity to the second connector base 104b. Each of the first contact 111c and the second contact 111d may include a sharp edge that is able to remove paint from the first side portion and the second side portion of the busway, respectively, and allow the first contract 111c and the second contact 111d to each form a ground connection between the electrical connector device 100 and the busway 20.

Additionally, first connector base 104a may include a lock 114. The lock 114 may be configured to prevent accidental disconnection of the plurality of connectors 106a, 106b, 106c, 106d from the connector tabs 28a, 28b, 28c, 28d once the electrical connector device 100 is coupled to the busway 20 as described hereinabove. More specifically, once the electrical connector device 100 is coupled to the busway 20, the lock 114 may slide longitudinally along the length of electrical connector device 100. The longitudinal movement of the lock 114 in the direction of arrow 90 (shown in FIG. 1) causes the lock 114 to slide within a corresponding channel, such as channel 34a (shown in FIG. 2), of the first busway outlet and hook onto an end of the corresponding channel to prevent unintended disconnection of the plurality of connectors 106a, 106b, 106c, 106d from the connector tabs 28a, 28b, 28c, 28d. Although the lock 114 is shown as a portion of the first connector base 104a, the second connector base 104b may similarly include a lock 114 to prevent unintended disconnection of the plurality of connectors 106e, 106f, 106g, 106h from the connector tabs 28a, 28b, 28c, 28d using a channel 34b of the second busway outlet. In some embodiments, each of the first connector base 104a and the second connector base 104b may include a lock 114 to prevent unintended disconnection of each the plurality of connectors 106a, 106b, 106c, 106d, 106e, 106f, 106g, 106h from the corresponding connector tabs 28a, 28b, 28c, 28d.

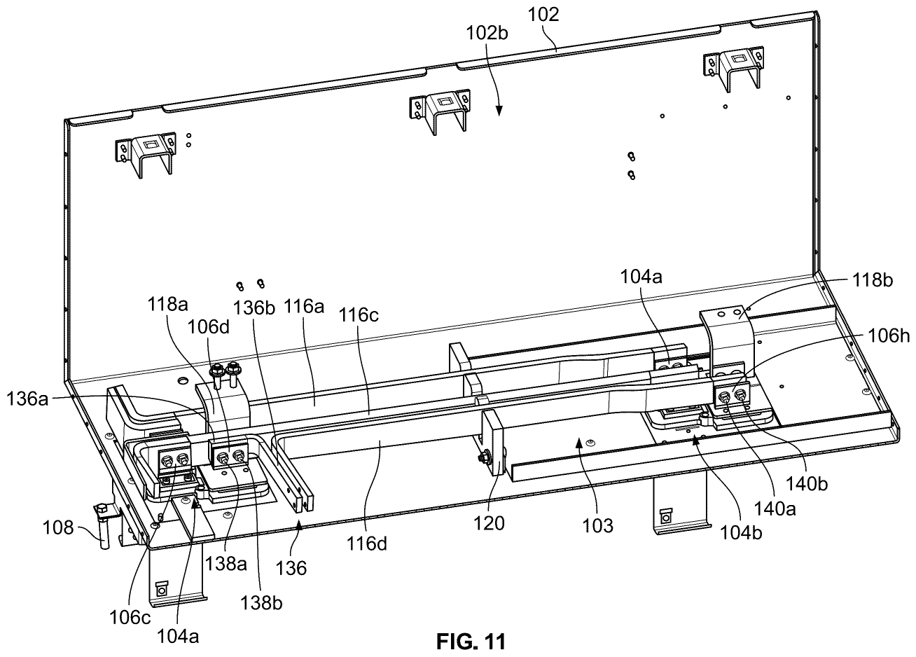

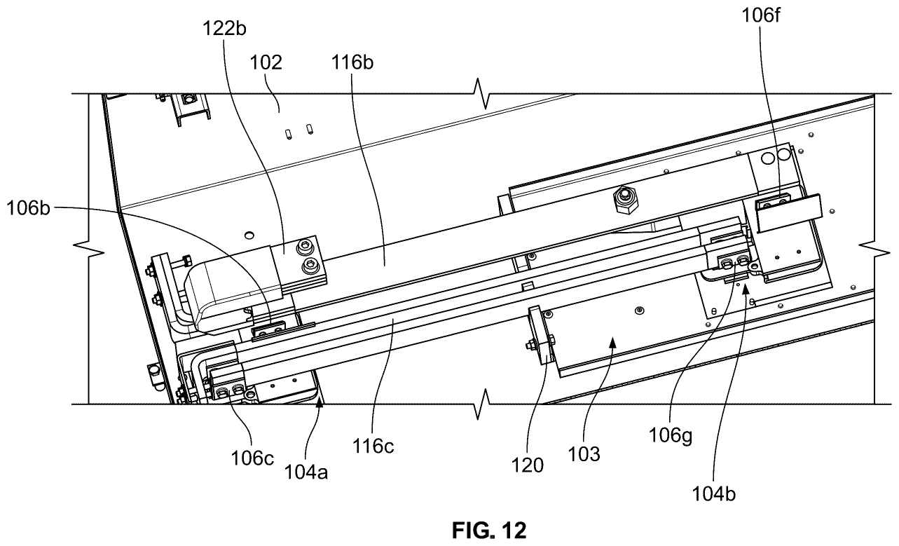

FIG. 6 depicts the electrical connector device 100 of FIG. 1 with a top portion and a front portion of the housing removed. FIG. 7 depicts the electrical connector device 100 of FIG. 1 with a top portion and side portions of the housing removed showing riser conductors 122a, 122b, 122c configured to establish a connection between the first connector base 104a and a breaker 124. As described above, the electrical connector device 100 includes the first connector base 104a and the second connector base 104b to establish a connection, such as an electrical connection, the busway 20 through the first busway outlet and the second busway outlet using a plurality of connectors 106a, 106b, 106c, 106d, 106e, 106f, 106g, 106h. The electrical connector device 100 includes a plurality of conductors 116a, 116b, 116c, 116d, shown more clearly in FIGS. 11 and 12. Each of the plurality of conductors 116a, 116b, 116c, 116d may be one of a busbar and a cable, but is not limited thereto. The plurality of conductors 116a, 116b, 116c, 116d is configured to establish at least one connection, such as at least one electrical connection, and enable a flow of electrical power between the first connector base 104a and second connector base 104b.

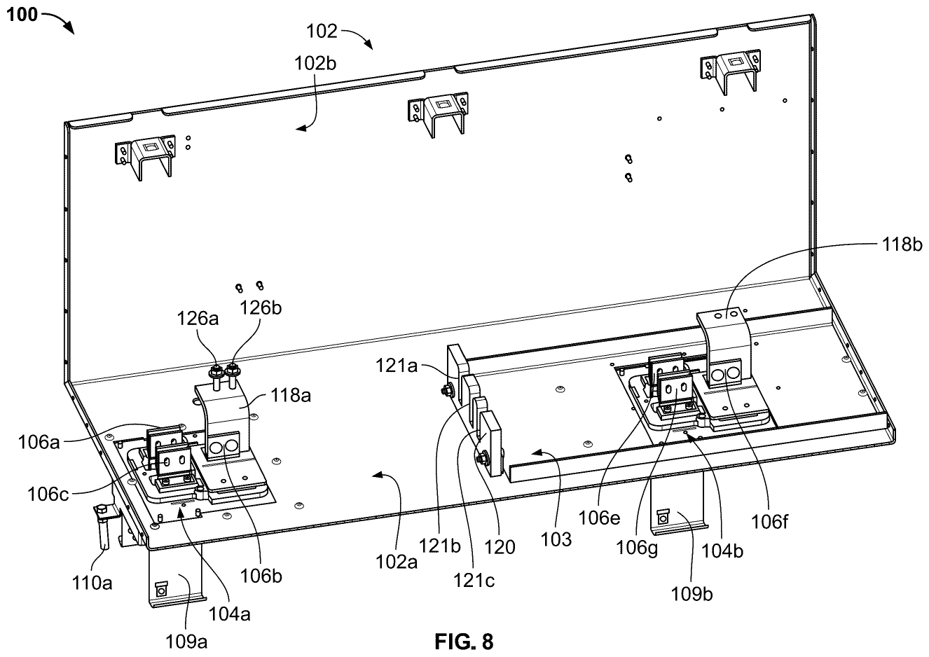

More specifically, a first end of a first conductor 116a is fixed to the first connector 106a and a second end of the first conductor 116a is fixed to the first connector 106e to establish a first electrical connection between the first connector base 104a and second connector base 104b. Additionally, a first end of a second conductor 116b is fixed to the second connector 106b and a second end of the second conductor 116b is fixed to the second connector 106f to establish a second electrical connection between the first connector base 104a and second connector base 104b. A first end of a third conductor 116c is fixed to the third connector 106c and a second end of the third conductor 116c is fixed to the third connector 106g to establish a third electrical connection between the first connector base 104a and second connector base 104b. A first end of a fourth conductor 116b is fixed to the fourth connector 106d and a second end of the fourth conductor 116d is fixed to the fourth connector 106h to establish a fourth electrical connection between the first connector base 104a and second connector base 104b. Additionally, the plurality of conductors 116a, 116b, 116c, 116d of the electrical connector device 100 may require a specific method of assembly to properly position each of the plurality of conductors 116a, 116b, 116c, 116d as shown in more detail in FIGS. 8-12.

Each of conductors 116a, 116b, 116c may be configured to enable a flow of electrical power in a specified electrical power phase between the first connector base 104a and the second connector base 104b. For example, the first conductor 116a may be configured to enable a flow of electrical power in the first electrical power phase (e.g., A-phase), the second conductor 116b may be configured to enable a flow of electrical power in the second electrical power phase (e.g., B-phase), and the third conductor 116c may be configured to enable a flow of electrical power in a third electrical power phase (e.g., C-phase). The fourth conductor 116d may be a neutral conductor that is configured to carry a neutral current and balance loads across each of conductors 116a, 116b, 116c.

Additionally, the plurality of conductors 116a, 116b, 116c, 116d may be configured to balance the first quantity of power drawn from the busway 20 using the connectors 106a, 106b, 106c, 106d and the second quantity of power drawn from the busway 20 using the connectors 106e, 106f, 106g, 106h. More specifically, the plurality of conductors 116a, 116b, 116c, 116d may be configured to balance the first quantity of power as required by the cross-sections and volumes of each of the plurality of conductors 116a, 116b, 116c, 116d to allow the electrical connector device 100 to draw increased amounts of current from the busway, such as busway 20, without decreasing thermal performance. For example, the electrical connector device 100 may be configured to draw about 800 amps of current from the busway 20 using connectors 106 a, 106 b, 106c, 106d, 106e, 106f, 106g, 106h and the current may be balanced by the plurality of conductors 116a, 116b, 116c, 116d. The balancing of the increased current load by 116a, 116b, 116c, 116d prevents overloading of the conductors 116a, 116b, 116c, 116d and thereby minimizes heat generated from the increased current load and prevents overheating of the conductors 116a, 116b, 116c, 116d to allow the electrical connector device 100 to handle the increased amount of electrical power from the busway without negatively affecting the electrical connector device 100, such as overheating of the electrical connector device 100.

The electrical connector device 100 may include a conductor support 120 disposed on the first portion 102a of the housing 102. The conductor support 120 may be configured to support at least one of the plurality of conductors, such as conductors 116a, 116c, and 116d (shown in FIG. 11), to prevent bending of these conductors. Additionally, the conductor support 120 may define a first channel 121a, a second channel 121b, and a third channel 121c. Each of the first channel 121a, a second channel 121b, and a third channel 121c may be configured to receive one of the plurality of conductors and provide separation along the length of the conductors. For example, as shown in FIG. 11, the first channel 121a is configured to receive and support the first conductor 116a, the second channel 121b is configured to receive and support the third conductor 116c, and the third channel 121c is configured to receive and support the neutral conductor 116d. The conductor support 120 may be configured to maintain spacing between conductors received by the first channel 121a, the second channel 121b, and the third channel 121c along the length of each conductor. More specifically, the first channel 121a, the second channel 121b, and the third channel 121c are longitudinally spaced on the conductor support 120 and the longitudinal spacing may define a spacing between the conductors received within the first channel 121a, the second channel 121b, and the third channel 121c. For example, as shown in FIG. 11, the spacing between the first channel 121a and the second channel 121b of conductor support 120 defines a spacing between the first conductor 116a and the third conductor 116c. In a further example, as shown in FIG. 11, the spacing between the second channel 121b and the third channel 121c of conductor support 120 defines a spacing between the third conductor 116c and the neutral conductor 116d.

The electrical connector device 100 may include a plurality of riser conductors. As shown in FIG. 7, the plurality of riser conductors includes a first riser conductor 122a, a second riser conductor 122b, and a third riser conductor 122c. The plurality of riser conductors may be configured to establish at least one connection, such as at least one electrical connection, between one of the plurality of conductors 116a, 116b, 116c, 116d and an electrical switch 124. More specifically, a first end of a first riser conductor 122a is fixed in electric communication with the first conductor 122a and a second end of the first riser conductor 122a is fixed in electric communication with the electronic switch 124 to establish an electrical connection between the first conductor 116a and the electrical switch 124. Additionally, a first end of a second riser conductor 122b is fixed in electric communication with the second conductor 116b and a second end of the second riser conductor 122b is fixed in electric communication with the electronic switch 124 to establish an electrical connection between the second conductor 116b and the electrical switch 124. A first end of a third riser conductor 122c is fixed in electric communication with the third conductor 116c and a second end of the third riser conductor 122c is fixed in electric communication with the electronic switch 124 to establish an electrical connection between the third conductor 116c and the electrical switch 124.

As described above, the balancing of power drawn by the first connector base 104a and the second connector base 104b by the plurality of conductors 116a, 116b, 116c, 116d prevents overloading and overheating of the conductors 116a, 116b, 116c, 116d to improve thermal performance. Additionally, the improved thermal performance of the electrical connector device 100 resulting from the conductors 116a, 116b, 116c, 116d may also allow each of the first riser conductor 122a, the second riser conductor 122b, and the third riser conductor 122c to also improve thermal performance of the electrical connector device 100. For example, the riser conductors 122a, 122b, 122c may also have cross-sections and volumes to minimize heated generated by the current load passing through the riser conductors 122a, 122b, 122c and, additionally, dissipate heat generated by the electrical switch 124. For example, each of the first riser conductor 122a, the second riser conductor 122b, and the third riser conductor 122c may have electrical power balanced to using respective cross-sections and volumes to minimize heating of riser conductors 122a, 122b, 122c caused by increased electrical power drawn from the busway 20 using the first connector base 104a and the second connector base 104b. The minimized heating of the riser conductors may allow the riser conductors 122a, 122b, 122c to each dissipate heat from the electrical switch 124 and prevent excess heat generation resulting from an increase in electrical power. The riser conductors 122a, 122b, 122c may additionally include any number of conductors to allow for increased heat dissipation as required by the electrical connector device 100. For example, as shown in FIG. 7, the first riser conductor 122a includes two conductors, the second riser conductor 123a includes three conductors, and the third riser conductor includes two conductors, but are not limited thereto.

Additionally, although the first riser conductor 122a, the second riser conductor 122b, and the third riser conductor 122c are shown to be positioned at an end of conductors 116a, 116b, 116c that is adjacent to the first connector base 104a, each of the riser conductors 122a, 122b, 122c may be positioned at any point between the first connector base 104a and the second connector base 104b along the conductors 116a, 116b, 116c based on a position of the electrical switch 124, as described below.

The electrical connector device 100 may include an electrical switch 124. The electrical switch 124 is configured to receive electrical power from the busway 20 through connectors 106a, 106b, 106c, conductors 116a, 116b, 116c, and riser conductors 122a, 122b, 122c. The electrical switch 124 is configured to allow or prevent the electrical power to flow between the busway 20 and a load through the electrical connector device 100. More specifically, the electrical switch 124 may be in an open or closed state to allow or prevent a flow of electrical power between the busway 20 and a load. The electrical switch 124 is configured to actuate from the closed state to the open state when the current flow exceeds a maximum current threshold to protect the load connected to the electrical connector device 100. Additionally, the electrical connector device 100 may be actuated between a first state (e.g., an on state) and a second state (e.g., an off state) based on the state of the electrical switch 124. For example, when the electrical switch 124 is closed and allows power to flow from the busway 20 to the load, the electrical connector device 100 may be in the first state. Additionally, when the electrical switch 124 is in open state and prevents power from flowing from the busway 20 to the load, the electrical connector device 100 may be in the second state. Although the electrical switch 124 is shown to be positioned adjacent to the first connector base 104a, the electrical switch 124 may be positioned at any location between the first connector base 104a and the second connector base 104b within the housing 102.

FIG. 8 depicts the first embodiment of the electrical connector device 100 of FIG. 1 with a top portion, a front portion, and side portions of the housing removed during a first assembly phase, showing a first riser bar 118a and a second riser bar 118b. As shown in FIG. 8, a first portion 102a and a second portion 102b for a housing 102 for an electrical connector device 100 is provided. The first portion 102a of the housing 102 includes a reinforced portion 103. As described above, the reinforced portion 103 provides added rigidity to the first portion 102a of housing 102 to prevent bending of the first portion 102a during installation of the electrical connector device 100 on a busway 20. Additionally, the electrical connector device 100 includes a first connector base 104a positioned adjacent to a first end of the first portion 102a of the housing 102 with the first connector base 104a initially having a first connector 106a, a second connector 106b, and a third connector 106c. The electrical connector device 100 includes a second connector base 104b positioned adjacent to a second end, opposite of the first end, of the first portion 102a within the reinforced portion 103, with the second connector base 104b initially having a first connector 106e, a second connector 106f, and a third connector 106g. Electrical connector device 100 additionally includes a conductor support 120 configured to support conductors, such as conductors 116a, 116c, and 116d as discussed above, positioned between the first connector base 104a and the second connector base 104b. Conductor support 120 may define a first channel 121a, a second channel 121b, and a third channel 121c, each configured to receive a conductor and provide separation between each conductor positioned in the first channel 121a, the second channel 121b, and the third channel 121c.

As shown in FIG. 8, during a first phase of assembly, a first riser bar 118a is installed on the second connector 106f of the first connector base 104a and a second riser bar 118b is installed on the second connector 106b. The first riser bar 118a and the second riser bar 118b may be installed on the second connectors 106b. 106f using fasteners with a desired length. For example, the fasteners may be a carriage bolt with a length of 1 inch, but is not limited thereto. Once the first riser bar 118a and the second riser bar 118b are installed, a first fastener 126a and a second fastener 126b may be loosely installed with a corresponding washer and a corresponding nut. In an exemplary embodiment, a first fastener 126a and a second fastener 126b may be any suitable fastener such as a carriage bolt but is not limited thereto.

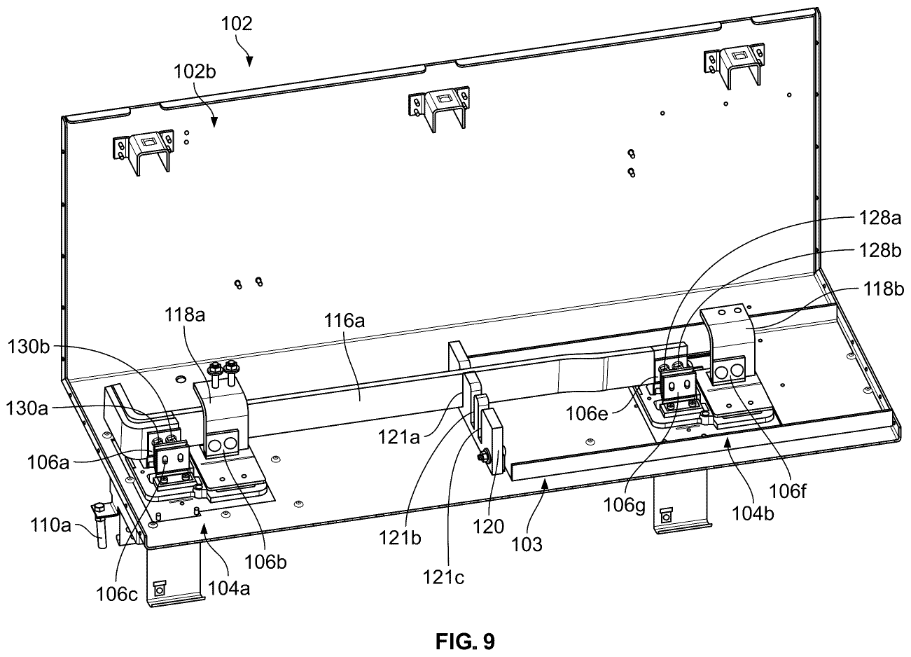

FIG. 9 depicts the electrical connector device 100 of FIG. 1 with a top portion, a front portion, and side portions of the housing removed during a second assembly phase, showing a first phase conductor 116a connecting the first connector base 104a and the second connector base 104b. In the second phase of assembly of the electrical connector device 100, the first phase conductor 116a is positioned between the first connector base 104a and the second connector base 104b. The first phase conductor 116a is also positioned within first channel 121a of conductor support 120. Once the first phase conductor 116a is properly positioned between the first connector base 104a and the second connector base 104b, the first phase conductor 116a may be fixed to the first connector 106e of the second connector base 104b using fasteners 128a, 128b with a desired length and corresponding nuts. For example, the fasteners 128a, 128b may be hex head bolts with a length of 1 inch, but is not limited thereto. In some embodiments, the fasteners 128a, 128b may be oriented such that the heads of the fasteners 128a, 128b are positioned closer to the second portion 102b of the housing 102 than the opposing end of the fasteners 128a, 128b. Once the first phase conductor 116a is fixed to the first connector 106e of the second connector base 104b, the first phase conductor 116a may be fixed to the first connector 106a of the first connector base 104a using fasteners 130a, 130b with a desired length and corresponding nuts. For example, the fasteners for the first phase conductor 116a may be hex head bolts with a length of 1.375 inches, but is not limited thereto. In some embodiments, the fasteners the first phase conductor 116a may be oriented such that the heads of the fasteners are positioned proximate the second portion 102b of the housing 102 than the opposing end of fasteners 130a, 130b.

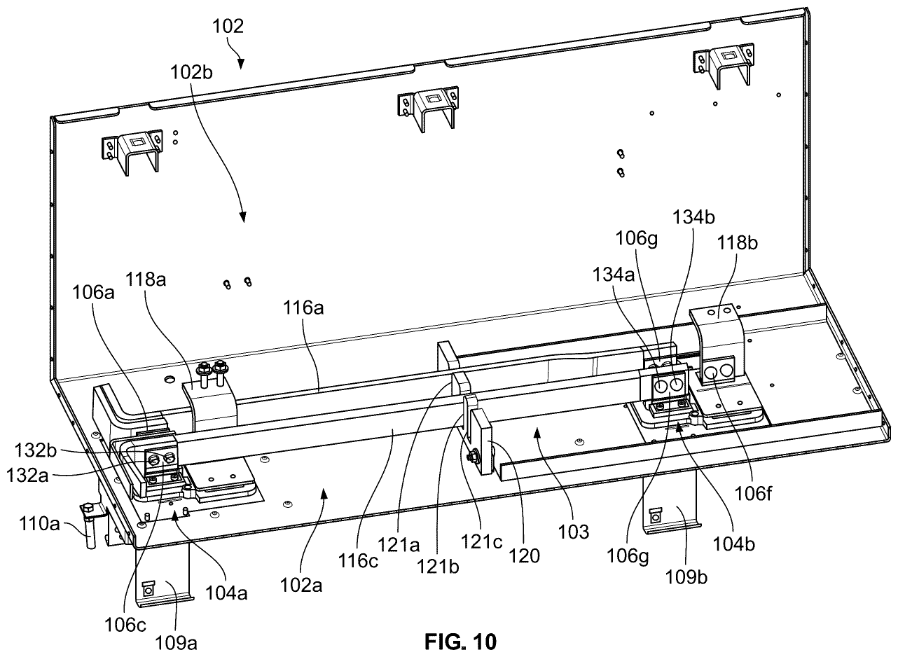

FIG. 10 depicts a perspective view of the electrical connector device 100 of FIG. 1 with a top portion, a front portion, and side portions of the housing removed during a third assembly phase of the first embodiment of the electrical connector device 100, showing a third phase conductor 116c connecting the first connector base 104a and the second connector base 104b. In the third phase of assembly of the electrical connector device 100, the third phase conductor 116c is positioned between the first connector base 104a and the second connector base 104b. The third phase conductor 116c is also positioned within second channel 121b of conductor support 120. Once the third phase conductor 116c is properly positioned between the first connector base 104a and the second connector base 104b, the third phase conductor 116c may be fixed to the third connector 106c of the first connector base 104a using fasteners 132a, 132b with a desired length and corresponding nuts. For example, the fasteners 132a, 132b may be hex head bolts with a length of 1.125 inches, but is not limited thereto. In some embodiments, the fasteners 132a, 132b may be oriented such that the heads of the fasteners 132a, 132b for the third phase conductor 116c are positioned distal to the second portion 102b of the housing 102 than the opposing end of fasteners 132a, 132b. Once the third phase conductor 116c is fixed to the third connector 106c of the first connector base 104a, the third phase conductor 116c may be fixed to the third connector 106f of the second connector base 104b using fasteners 134a, 134b with a desired length and corresponding nuts. For example, the fasteners 134a, 134b, may be carriage bolts with a length of 1 inch, but is not limited thereto. In some embodiments, the fasteners 134 a, 134b may be oriented such that the heads of the fasteners are positioned further from the second portion 102b of the housing 102 than the opposing end of the fasteners 134a, 134b.

FIG. 11 depicts the electrical connector device 100 of FIG. 1 with a top portion, a front portion, and side portions of the housing removed during a fourth assembly phase of the electrical connector device 100, showing a neutral conductor 116d connecting the first connector base 104a and the second connector base 104b. In the fourth phase of assembly of the electrical connector device 100, a fourth connector 106d is removed from the first connector base 104a and an L-shaped conductor 136 is fixed to the fourth connector 106d using fasteners 138a, 138b with a desired length and corresponding nuts. For example, the fasteners 138a, 138b may be carriage bolts with a length of 1 inch, but is not limited thereto. In some embodiments, the fasteners 138 a, 138b may be oriented such that the heads of the fasteners 138a, 138b for the neutral conductor 116d are positioned nearer the second portion 102b of the housing 102 than the opposing end of fasteners 138a, 138b once the fourth connector 106d is reinstalled into the first connector base 104a. The L-shaped conductor 136 may be oriented with a first portion 136a of the conductor 136 fixed to the a fourth connector 106d and the second portion 136b of the conductor 136 extends away from portion 102b of the housing 102.

The neutral conductor 116d is positioned between the first connector base 104a and the second connector base 104b and within third channel 121c of conductor support 120. Once the neutral conductor 116d is properly positioned between the first connector base 104a and the second connector base 104b, the neutral conductor 116d may be fixed to the fourth connector 106h of the second connector base 104b using fasteners 140a, 140b with a desired length. For example, the fasteners for the neutral conductor may be carriage bolts with a length of 1 inch, but is not limited thereto. In some embodiment, the fasteners 140a, 140b may be oriented such that the heads of the fasteners are positioned proximate the second portion 102b of the housing 102 than the opposing end of the fastener 140a, 140b.

FIG. 12 depicts the electrical connector device 100 of FIG. 1 with a top portion, a front portion, and side portions of the housing removed during a fifth assembly phase the electrical connector device 100, showing a second phase conductor 116b connecting the first connector base 104a and the second connector base 104b using the first riser bar 118a and the second riser bar 118b. In the fifth phase of assembly of the electrical connector device 100, the corresponding washer and the corresponding nut are removed from the first fastener 126a and the second fastener 126b. Once the corresponding washer and the corresponding nut are removed from each of the first fastener 126a and the second fastener 126b, the second phase conductor 116b is positioned on the first riser bar 118a and the second riser bar 118b and fixed to the second riser bar 118b using fasteners. Additionally, the second phase conductor 116 is fixed to the first riser bar 118a by reinstalling the corresponding nut and the corresponding washer on the first fastener 126a and the second fastener 126b. Once the second phase conductor 116 is installed on the first riser bar 118a, other internal components of the electrical connector device 100, such as electrical switch 124, riser busbars 122a, 122b, 122c, 122d, but not limited thereto, may be assembled within housing 102.

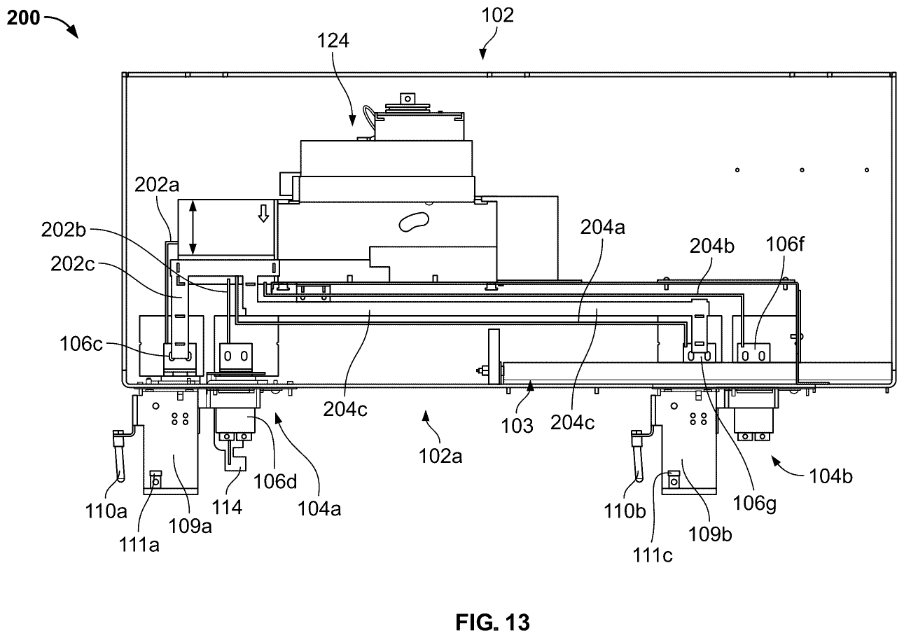

FIG. 13 depicts a second embodiment 200 of an electrical connector device with a front portion of the housing removed. The electrical connector device 200 may include features from electrical connector device 100. For example, as shown in FIG. 13, the electrical connector device 200 includes housing 102, first connector base 104a, second connector base 104 b, connectors 106a, 106b, 106c, 106d, brackets 109a, 109b, alignment pins 110a, 110b, lock 114, and electrical switch 124, but is not limited thereto. The electrical connector device 200 includes a plurality of conductors 202a, 202b, 202c, 204a, 204b, 204c. In an exemplary embodiment, the plurality of conductors 202a, 202b, 202c, may be a busbar, but are not limited thereto. Additionally, the plurality of conductors 204a, 204b, 204c may be one of a busbar and a cable, but are not limited thereto.

Conductors 202a, 202b, 202c are configured to establish connections, such as electrical connections, between the first connector base 104a and electrical switch 124. More specifically, a first end of conductor 202a is fixed in electric communication with the first connector 106a of the first connector base 104a and a second end of conductor 202a is fixed in electric communication with the electronic switch 124 to establish a first electrical connection between the first connector base 104a and the electrical switch 124. Additionally, a first end conductor 202b is fixed in electric communication with the second connector 106b of the first connector base 104a and a second end of conductor 202b is fixed in electric communication with the electronic switch 124 to establish a second electrical connection between the first connector base 104a and the electrical switch 124. A first end of conductor 202c is fixed in electric communication with the third connector 106c of the first connector base 104a and a second end of the conductor 202c fixed in electric communication with the electronic switch 124 to establish a third electrical connection between the first connector base 104a and the electrical switch 124.

Conductors 204a, 204b, 204c are configured to establish connections, such as electrical connections, between the second connector base 104b and electrical switch 124. More specifically, a first end of conductor 204a is fixed in electric communication with the first connector 106e of the second connector base 104b and a second end of the conductor 204a is fixed in electric communication with the electronic switch 124 to establish a first electrical connection between the second connector base 104b and the electrical switch 124. Additionally, a first end of conductor 204b is fixed in electric communication with the second connector 106f of the second connector base 104b and a second end of the conductor 204b is fixed in electric communication with the electronic switch 124 to establish a second electrical connection between the second connector base 104b and the electrical switch 124. A first end of conductor 204c may be fixed in electric communication with the third connector 106g of the second connector base 104b and a second end of the conductor 204c is fixed in electric communication with the electronic switch 124 to establish a third electrical connection between the first connector base 104a and the electrical switch 124.

Each of conductors 202a, 202b, 202c may be configured to enable a flow of electrical power in a specified electrical power phase between the first connector base 104a and the electrical switch 124. Additionally, each of conductors 204a, 204b, 204c may be configured to enable a flow of electrical power in a specified electrical power phase between the second connector base 104b and the electrical switch 124. For example, conductor 202a and conductor 204a may each be configured to enable a flow of electrical power in the first electrical power phase from the first connector base 104a and second connector base 104b, respectively, to the electrical switch 124, conductor 202b and conductor 204b may each be configured to enable a flow of electrical power in the second electrical power phase from the first connector base 104a and second connector base 104b, respectively, to the electrical switch 124, and conductor 202c and conductor 204c may each be configured to enable a flow of electrical power in a third electrical power phase from the first connector base 104a and second connector base 104b, respectively, to the electrical switch 124.

The plurality of conductors 202a, 202b, 202c, 204a, 204b, 204c may be configured to balance the first quantity of power drawn by the first connector base 104a and the second connector base 104b from the busway 20 to allow the electrical connector device 200 to handle and draw greater amounts of current and electrical power. More specifically, conductor 202a and conductor 204a may be configured to balance the first quantity of power in a first phase drawn through the first connector 106a and the second quantity of power in the first phase drawn through the first connector 106e from the busway 20 to allow the first quantity and the second quantity to be substantially similar. In addition, conductor 202b and conductor 204b may be configured to balance the first quantity of power in a second phase drawn through the second connector 106b and the second quantity of power in the second phase drawn through the second connector 106f from the busway 20 to allow the first quantity and the second quantity to be substantially similar. Conductor 202c and conductor 204c may be configured to balance the first quantity of power in a third phase drawn through the third connector 106c and the second quantity of power in the third phase drawn through the second connector 104g from the busway 20 to allow the first quantity and the second quantity to be substantially similar.

Similar to the power balancing by the plurality of conductors 116a, 116b, 116c, 116d, the power balancing by the plurality of conductors 202a, 202b, 202c, 204a, 204b, 204c prevents overloading and overheating of the conductors 202a, 202b, 202c, 204a, 204b, 204c to improve thermal performance of electrical connector device 200. Subsequently, conductors 202a, 202b, 202c, 204a, 204b, 204c may additionally improve thermal performance by improving heat dissipation from the electrical switch 124. The minimized heating of the conductors 202a, 202b, 202c, 204a, 204b, 204c to each dissipate an increased amount of heat from generated by the electrical switch 124 and prevent excessive heat generation within electrical connector device 200 resulting from the increase in electrical power drawn from the busway 20 by electrical connector device 200 through the first connector base 104a and the second connector base 104b. Conductors 202a, 202b, 202c, 204a, 204b, 204c may each comprise any number of conductors for load balancing and heat dissipation as required by the electrical connector device 200.

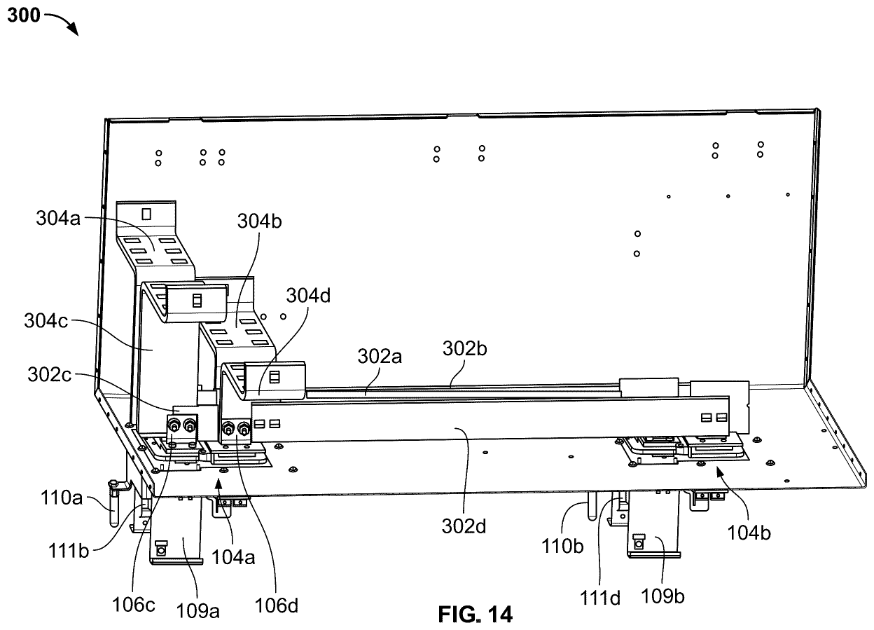

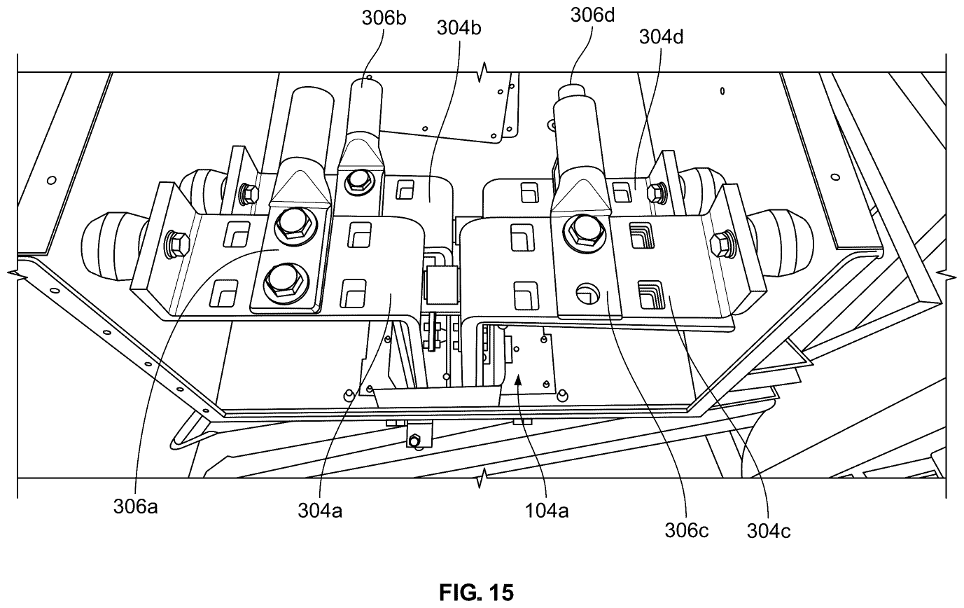

FIG. 14 depicts a third embodiment of an electrical connector device 300 with a top portion, a bottom portion, a front portion, and a back portion of the housing removed. FIG. 15 depicts the third embodiment 300 of an electrical connector device with a top portion and side portions of the housing removed, showing a plurality of lugs 306a, 306b, 306c, 306d. The electrical connector device 300 may include features from electrical connector device 100. For example, the electrical connector device 300 includes housing 102, first connector base 104a, second connector base 104b, connectors 106a, 106b, 106c, 106d, brackets 109a, 109b, and lock 114, but is not limited thereto. As shown in FIG. 14, electrical connector device 300 omits an electrical switch, such as electrical switch 124. The electrical connector device 300 includes a plurality of conductors 302a, 302b, 302c, 302d. Each of the plurality of conductors 302a, 302b, 302c, 302d may be one of a busbar and a cable, but is not limited thereto. The plurality of conductors 302a, 302b, 302c, 302d may be configured to establish at least one connection, such as at least one electrical connection, between the first connector base 104a and second connector base 104b.

A first end of a first conductor 302a is fixed to the first connector 106a of the first connector base 104a and a second end of the first conductor 302 is fixed to the first connector 106e of the second connector base 104b at a second end of the first conductor 116a to establish a first electrical connection between the first connector base 104a and second connector base 104b. Additionally, a first end of the a second conductor 302b is fixed to the second connector 106b of the first connector base 104a and a second end of the second conductor 302b is fixed to the second connector 106f of the second connector base 104b to establish a second electrical connection between the first connector base 104a and second connector base 104b. A first end of a third conductor 302c is fixed to the third connector 106c of the first connector base 104a and a second end of the third conductor 302c is fixed to the third connector 106g of the second connector base 104b to establish a third electrical connection between the first connector base 104a and second connector base 104b. A first end of a fourth conductor 302d is fixed to the fourth connector 106d of the first connector base 104a and a second end of the fourth conductor 302d is fixed to the fourth connector 106h of the second connector base 104b to establish a fourth electrical connection between the first connector base 104a and second connector base 104b.

Each of conductors 302a, 302b, 302c may be configured to enable a flow of electrical power in a specified electrical power phase between the first connector base 104a and the second connector base 104b. For example, the first conductor 302a may be configured to enable a flow of electrical power in the first electrical power phase (e.g., A-phase), the second conductor 302b may be configured to enable a flow of electrical power in the second electrical power phase (e.g., B-phase), and the third conductor 302c may be configured to enable a flow of electrical power in a third electrical power phase (e.g., C-phase). Fourth conductor 302d may be a neutral conductor that is configured to carry a neutral current and balance loads across each of the first electrical power phase, the second electrical power phase, and the third electrical power phase.

The plurality of conductors 302a, 302b, 302c, 302d may be configured to balance the first quantity of power and the second quantity of power drawn from the busway 20. The plurality of conductors 302a, 302b, 302c, 302d may be configured to balance the first quantity of power drawn from the busway 20 by the first connector base 104a and the second quantity of power drawn from the busway 20 by the second connector base 104b are required by the cross-sections and volumes of each of the plurality of conductors 302a, 302b, 302c, 302d to improve thermal performance of the electrical connector device 300 to allow the electrical connector device 300 to handle and draw increased amounts of current and electrical power without negatively affecting the electrical connector device 300.

The electrical connector device 300 includes a plurality of riser conductors 304a, 304b, 304c, 304d to establish a connection, such as an electrical connection, between the first connector base 104a and a plurality of lugs 306a, 306b, 306c, 306d (shown in FIG. 15). Each of the plurality of lugs 306a, 306b, 306c, 306d may be configured to pull electrical power for use by the load. Each of the plurality of lugs 306a, 306b, 306c, 306d may be selected based on an amperage rating for each lug and an amperage needed by the load to ensure safe operation of the electrical connector device 300. The amperage rating is an indicator for a maximum current a lug can safely handle before an issue, such as overheating of the lug, arises. As such, each of the plurality of lugs 306a, 306b, 306c, 306d may have an amperage rating that is at least equal to or greater than the amperage needed by the load to ensure safe operation of the electrical connector device 300.

Additionally, the plurality of riser conductors 304a, 304b, 304c, 304d may establish an electrical connection with the second connector base 104b through the plurality of conductors 302a, 302b, 302c, 302d connecting the second connector base 104b and the first connector base 104a. More specifically, the first lug 306a is electrically connected with the first connector 106e by conductor 302a and riser conductor 304a, a second lug 306b is electrically connected with the second connector 106f by conductor 302b and riser conductor 304b, a third lug 306c is electrically connected with the third connector 106g by conductor 302c and riser conductor 304c, and a fourth lug 306d is electrically connected with a fourth connector 106h by conductor 302d and riser conductor 304d.

Alternatively, in an embodiment, the plurality of conductors 304a, 304b, 304c, 304d may be configured to connect each of the plurality of lugs 306a, 306b, 306c, 306d to the second connector base 104b. For example, the first lug 306a may be electrically connected with the first connector 106e of second connector base 104b by conductor 304a, the second lug 306b may be electrically connected with the second connector 106f of second connector base 104b by conductor 304b, the third lug 306c may be electrically connected with the third connector 106g of second connector base 104b by conductor 304c, and the fourth lug 306d may electrically connected with the fourth connector 106h of second connector base 104b by conductor 304d.

As used herein, an element or step recited in the singular and proceeded with the word “a” or “an” should be understood as not excluding plural elements or steps unless such exclusion is explicitly recited. Furthermore, references to “one embodiment” of the disclosure or an “exemplary” or “example” embodiment are not intended to be interpreted as excluding the existence of additional embodiments that also incorporate the recited features. Likewise, limitations associated with “one embodiment” or “an embodiment” should not be interpreted as limiting to all embodiments unless explicitly recited.

Disjunctive language such as the phrase “at least one of X, Y, or Z,” unless specifically stated otherwise, is generally intended, within the context presented, to disclose that an item, term, etc. may be either X, Y, or Z, or any combination thereof (e.g., X, Y, and/or Z). Likewise, conjunctive language such as the phrase “at least one of X, Y, and Z,” unless specifically stated otherwise, is generally intended, within the context presented, to disclose at least one of X, at least one of Y, and at least one of Z.

The disclosed systems and methods are not limited to the specific embodiments described herein. Rather, components of the systems or steps of the methods may be utilized independently and separately from other described components or steps.

This written description uses examples to disclose various embodiments, which include the best mode, to enable any person skilled in the art to practice those embodiments, including making and using any devices or systems and performing any incorporated methods. The patentable scope is defined by the claims and may include other examples that occur to those skilled in the art. Such other examples are intended to be within the scope of the claims if they have structural elements that do not differ from the literal language of the claims, or if they include equivalent structural elements with insubstantial differences from the literal language of the claims.

We claim:

1. An electrical connector device configured to connect to a busway to provide electrical power to a device, the electrical connector device comprising:
a housing body;
a first connector base disposed on a first portion of the housing body, the first connector base comprising a first plurality of connectors configured to couple to a first outlet on the busway and draw a first quantity of electrical power from the busway through the first outlet;
a second connector base disposed on the first portion of the housing body, the second connector base comprising a second plurality of connectors configured to couple to a second outlet on the busway and draw a second quantity of electrical power from the busway through the second outlet; and
at least one conductor disposed within the housing body, wherein the at least one conductor is configured to electrically connect the first connector base and the second connector base and balance the first quantity of electrical power and the second quantity of electrical power.

2. The electrical connector device of claim 1, wherein the housing body comprises a reinforced portion on the first portion of the housing body.

3. The electrical connector device of claim 2, wherein the second connector is disposed within the reinforced portion of the housing body.

4. The electrical connector device of claim 1, wherein the at least one conductor comprises a first power phase conductor for a first power phase of a plurality of power phases, a second power phase conductor for a second power phase of the plurality of power phases, a third power phase conductor for a third power phase of the plurality of power phases, and a neutral conductor.

5. The electrical connector device of claim 4, further comprising:
a first riser bar coupled to a connector of the first plurality of connectors; and
a second riser bar coupled to a connector of the second plurality connectors,
wherein the second phase conductor connects the first riser bar and the second riser to form an electrical connection for the second phase between the first connector base and the second connector base, and
wherein the first riser and the second riser are configured to space the second phase conductor from each of the first phase conductor, the third phase conductor, and the neutral conductor.

6. The electrical connector device of claim 4, further comprising a conductor support disposed on the first portion of the housing body between the first connector base and the second connector base, wherein the support is configured to support each of the first phase conductor, the third phase conductor, and the neutral conductor.

7. The electrical connector device of claim 1, further comprising:
a support positioned on an end of the housing body proximate the first connector base, the support comprising a bracket, a first hook configured to engage a lip on an edge of a first side of a housing of the busway and a second hook configured to engage a lip on an edge of a second side of the housing of the busway; and
a connector attachment assembly configured to engage the support to connect the first plurality of connectors and the first outlet.

8. The electrical connector device of claim 4, further comprising:
an electrical switch configured to control a flow of electricity through the electrical connector device;
at least one riser conductor disposed within the housing, wherein each of the at least riser one conductor is configured to electrically connect one of the at least one conductor and the electrical switch.

9. An electrical connector device configured to connect to a busway to provide electrical power to a device, the electrical connector device comprising:
a housing body;
a first connector base disposed on a first portion of the housing body, the first connector base comprising a first plurality of connectors configured to couple to a first outlet on the busway and draw a first quantity of electrical power from the busway through the first outlet;
a second connector base disposed on the first portion of the housing body, the second connector base comprising a second plurality of connectors configured to couple to a second outlet on the busway and draw a second quantity electrical power from the busway through the second outlet;
an electrical switch disposed within the housing, the electrical switch configured to actuate between a closed position to allow a current flow through the electrical connector device and an open position to interrupt the current flow;
a first plurality of conductors disposed within the housing, wherein the first plurality of conductors are configured to electrically connect the first connector base and the electrical switch; and
a second plurality of conductors disposed within the housing, wherein the second plurality of conductors are configured to electrically connect the second connector base and the electrical switch.

10. The electrical connector device of claim 9, wherein the first plurality of conductors comprises a first conductor electrically connecting a first connector of the first plurality of connectors and the electrical switch, a second conductor electrically connecting a second connector of the first plurality of connectors and the electrical switch, and a third conductor electrically connecting a third connector of the first plurality of connectors and the electrical switch.

11. The electrical connector device of claim 10, wherein the second plurality of conductors comprises a fourth conductor electrically connecting a first connector of the second plurality of connectors and the electrical switch, a fifth conductor electrically connecting a second connector of the second plurality of connectors and the electrical switch, and a sixth conductor electrically connecting a third connector of the second plurality of connectors and the electrical switch.

12. The electrical connector device of claim 11, wherein the first conductor and the fourth conductor are configured to balance the first quantity of power in a first phase drawn through the first connector of the first plurality of connectors and the second quantity of power in the first phase drawn through the first connector of the second plurality of connectors.

13. The electrical connector device of claim 12, wherein the second conductor and the fifth conductor are configured to balance the first quantity of power in a second phase drawn through the second connector of the first plurality of connectors and the second quantity of power in the second phase drawn through the second connector of the second plurality of connectors.

14. The electrical connector device of claim 13, wherein the third conductor and the sixth conductor are configured to balance the first quantity of power in a third phase drawn through the third connector of the first plurality of connectors and the second quantity of power in the third phase drawn through the third connector of the second plurality of connectors.

15. A method of assembly for an electrical connector device, comprising:
providing a housing body for the electrical connector device;
providing a first connector base on a first portion of the housing, the first connector base configured to couple to a first outlet on the busway and draw electrical power from the busway;
providing a second connector base on the first portion of the housing, the second connector base configured to couple to a second outlet on the busway and draw additional electrical power from the busway; and
connecting the first connector base and the second connector base by at least one conductor, wherein the at least one conductor comprises a first phase conductor for a first phase of a plurality of phases, a second phase conductor for a second phase of the plurality of phases, a third phase conductor for a third phase of the plurality of phases, and a neutral conductor.

16. The method of assembly of claim 15, wherein connecting the first connector base and the second connector base by at least one conductor comprises:
coupling a first riser bar for the second phase conductor to the first connector base; and
coupling a second riser bar for the second phase conductor to the second connector base.

17. The method of assembly of claim 16, wherein connecting the first connector base and the second connector base by at least one conductor further comprises:
positioning the first phase conductor between the first connector base and the second connector base;
coupling the first phase conductor to the second connector base; and
coupling the first phase conductor to the first connector base after coupling the first phase conductor to the second connector base.

18. The method of assembly of claim 17, wherein connecting the first connector base and the second connector base by at least one conductor further comprises:
positioning the third phase conductor between the first connector base and the second connector base;
coupling the third phase conductor to the first connector base; and
coupling the third phase conductor to the second connector base after coupling the third phase conductor to the first connector base.

19. The method of assembly of claim 18, wherein connecting the first connector base and the second connector base by at least one conductor further comprises:
positioning the neutral conductor between the first connector base and the second connector base;
coupling the neutral conductor to the first connector base; and
coupling the neutral conductor to the second connector base after coupling the neutral conductor to the first connector base.

20. The method of assembly of claim 19, wherein connecting the first connector base and the second connector base by at least one conductor further comprises:
coupling the second phase conductor to each of the first riser bar and the second riser bar after each of the first phase conductor, the third phase conductor, and the neutral conductor are coupled to each of the first connector base and the second connector base.
